(19) United States
(12) Patent Application Publication
(10) Pub. No.: US 2007/0076804 A1
(43) Pub. Date: Apr. 5, 2007

(54) Image-rejecting channel estimator, method of image-rejection channel estimating and an OFDM receiver employing the same

(75) Inventors: Charles K. Sestok IV, Dallas, TX (US); Anand G. Dabak, Plano, TX (US); Jaiganesh Balakrishnan, Bangalore (IN)

Correspondence Address: TEXAS INSTRUMENTS INCORPORATED, P O BOX 655474, M/S 3999, DALLAS, TX, 75265, US

(73) Assignee: Texas Instruments Inc., Dallas, TX (US)

(21) Appl. No.: 11/240,203

(22) Filed: Sep. 30, 2005

(51) Int. Cl. H04K 1/10

(52) U.S. Cl. 375/260

(57) ABSTRACT

The present invention provides an image-rejecting channel estimator for use with an orthogonal frequency division multiplex (OFDM) receiver employing scattered pilot channel estimates. In one embodiment, the image-rejecting channel estimator includes an estimation interpolator configured to provide channel estimates through time interpolation and frequency interpolation employing the scattered pilot channel estimates. The image-rejecting channel estimator also includes an image-rejection formatter coupled to the estimation interpolator and configured to provide image-rejection filtering to suppress an image in an output spectrum of the channel estimates from at least one of the time interpolation and frequency interpolation.

### TECHNICAL FIELD OF THE INVENTION

The present invention is directed, in general, to communication systems and, more specifically, to an image-rejection channel estimator, a method of image-rejection channel estimating and an OFDM receiver employing the estimator or the method.

### BACKGROUND OF THE INVENTION

Orthogonal Frequency Domain Modulation (OFDM) is a popular modulation technique for wireless communications. It has been adopted in standards for technologies such as wireless networks (802.11a/g), digital television broadcasting (DVB-T/S/H and ISDB-T), and broadband wireless local loops (802.16e/WiMax). An OFDM wireless transmitter broadcasts information consisting of symbols to an OFDM receiver employing a wireless communication channel between the transmitter and the receiver. The characteristics of this communication channel typically vary over time due to changes in the transmission path. The performance of the entire communication system hinges on the ability of the receiver to establish a reliable representation of the transmitted symbol. This necessitates that the receiver provide an appropriate channel estimate of the transmission channel.

In OFDM communication systems, channel equalization is performed in the frequency domain. Each block of data is preceded by a cyclic prefix, ensuring that the sub-carriers generated by a fast Fourier transform (FFT) of a properly chosen block of data are orthogonal. This allows a linear time-invariant channel to be easily equalized in the frequency domain. Practical OFDM communication systems estimate the channel using values provided from a set of pilot tones. The receiver generates samples of the channel's frequency response by dividing the received values at these tones by the modulated training data. The channel estimates at the data tones are estimated from these samples.

The estimates can be generated by two-dimensional interpolation over a number of buffered OFDM symbols. The interpolation may be broken into two stages consisting of time interpolation followed by frequency interpolation. However, interpolation errors due to unwanted images generated during the channel estimation process degrade the quality of the communication channel. This, in turn, reduces the overall performance of the communication system.

Accordingly, what is needed in the art is a more effective way to overcome the effects of interpolation errors in channel estimation.

### SUMMARY OF THE INVENTION

To address the above-discussed deficiencies of the prior art, the present invention provides an image-rejecting channel estimator for use with an orthogonal frequency division multiplex (OFDM) receiver employing scattered pilot channel estimates. In one embodiment, the image-rejecting channel estimator includes an estimation interpolator configured to provide channel estimates through time interpolation and frequency interpolation employing the scattered pilot channel estimates. The image-rejecting channel estimator also includes an image-rejection formatter coupled to the estimation interpolator and configured to provide image-rejection filtering to suppress an image in an output spectrum of the channel estimates from at least one of the time interpolation and frequency interpolation.

In another aspect, the present invention provides a method of image-rejection channel estimating for use with an orthogonal frequency division multiplex (OFDM) receiver employing scattered pilot channel estimates. The method includes providing channel estimates through time interpolation and frequency interpolation employing the scattered pilot channel estimates and providing image-rejection filtering to suppress an image in an output spectrum of the channel estimates from at least one of the time interpolation and frequency interpolation.

The present invention also provides, in yet another aspect, an orthogonal frequency division multiplex (OFDM) receiver employing scattered pilot data. The OFDM receiver includes a guard band removal section coupled to a communication channel, a fast Fourier transform (FFT) section coupled to the guard band removal section and a channel estimation section, coupled to the FFT section, that provides scattered pilot channel estimates from the scattered pilot data. The OFDM receiver also includes an image-rejecting channel estimator, coupled to the channel estimation section, having an estimation interpolator that provides channel estimates through time interpolation and frequency interpolation employing said scattered pilot channel estimates. The image-rejecting channel estimator also has an image-rejection formatter, coupled to the estimation interpolator, that provides image-rejection filtering to suppress an image in an output spectrum of the channel estimates from at least one of the time interpolation and frequency interpolation. The OFDM receiver further includes a demapping section, coupled to the channel estimation section, that provides output data.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates an embodiment of an OFDM communication system constructed in accordance with the principles of the present invention;

FIG. 2 illustrates a diagram of an embodiment of a symbol-carrier matrix showing three stages of channel estimate populations;

FIG. 3 illustrates an IFFT magnitude of a time interpolation output showing undesired images of the communication channel impulse response;

FIG. 4A illustrates a diagram of an embodiment of an image-rejecting filter template, generally designated 400, constructed in accordance with the principles of the present invention;

FIG. 4B illustrates a windowing function of an embodiment of an image-rejecting filter constructed employing the image-rejecting filter template of FIG. 4A;

FIG. 5 illustrates a windowing function of an embodiment of image-rejecting frequency interpolation filter constructed according to the principles of the present invention as may be employed for the time interpolation pattern shown in FIG. 2;

FIG. 6 illustrates a windowing function of an embodiment of an image-rejecting time interpolation filter constructed according to the principles of the present invention as may be employed for the pilot carrier pattern shown in FIG. 2;

FIG. 7 illustrates a comparative chart of channel estimate magnitudes showing an enhancement afforded by image-rejecting channel estimation.

FIG. 8 illustrates a comparative chart of bit error rates showing an enhancement afforded by image-rejecting channel estimation; and

FIG. 9 illustrates a flow diagram of an embodiment of a method of image-rejecting channel estimation carried out in accordance with the principles of the present invention.

### DETAILED DESCRIPTION

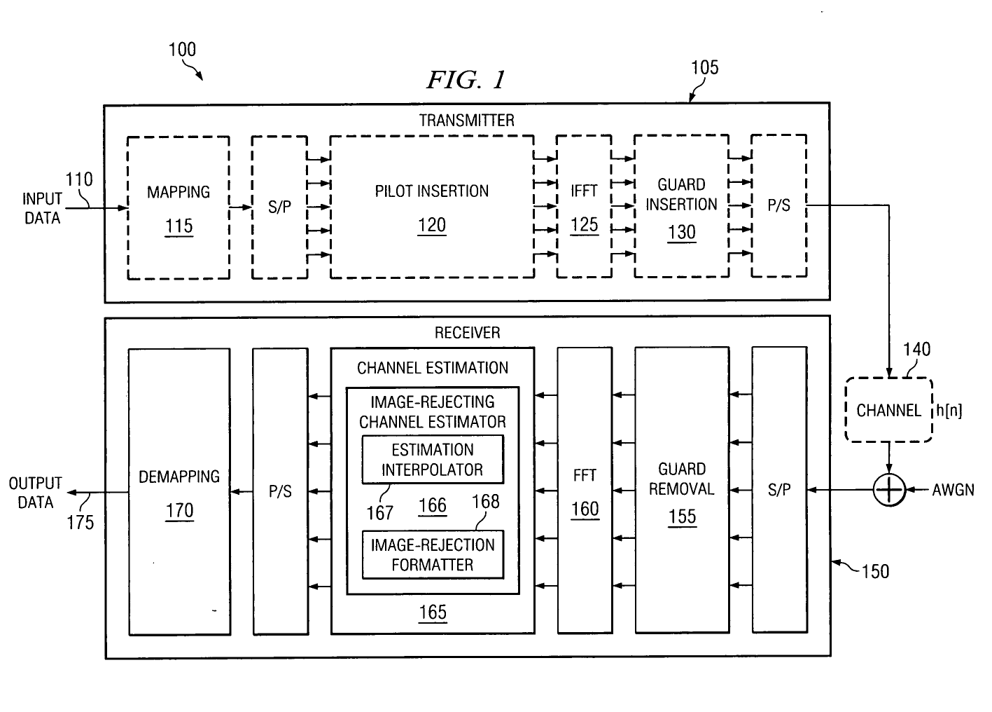

Referring initially to FIG. 1, illustrated is an embodiment of an OFDM communication system, generally designated 100, constructed in accordance with the principles of the present invention. The OFDM communication system 100 includes a transmitter 105, a communication channel 140 and a receiver 150. The transmitter 105 includes a mapping section 115 that employs input data 110, a pilot insertion section 120, an inverse fast Fourier transform (IFFT) section 125 and a guard insertion section 130. The receiver 150 includes a guard removal section 155, a fast Fourier transform (FFT) section 160, a channel estimation section 165 including an image-rejection channel estimator 166 and a demapping section 170 that provides output data 175.

The ODFM communication system 100 is based on pilot-aided channel estimation. The input data 110 are first grouped and mapped according to the modulation in the mapping section 115. Insertion of pilots scattered between input data sequences occurs in the pilot insertion section 120. The IFFT section 125 is employed to transform the data sequence into a time domain signal. Guard interval data, which is chosen to be larger that the expected transmission delay spread, is inserted in the guard insertion section 130 to prevent inter-symbol interference. This guard time includes a cyclically extended portion of the OFDM symbol to eliminate inter-symbol interference. A transmitted signal then passes through a time varying, frequency selective and fading channel 140 having a channel delay profile h[n] and is influenced by Additive White Gaussian Noise (AWGN).

The receive signal is then the result of the transmitted signal acted on by the channel delay profile h[n] and the AWGN. Guard interval data is removed in the guard removal section 155 and the FFT section 160 provides a transformed receive signal. Following the FFT section 160, the scattered pilot signals are extracted and employed by the channel estimation section 165 to provide scattered pilot channel estimates. The image-rejecting channel estimator 166 processes the scattered pilot channel estimates, producing refined channel estimates for all carriers. Then, the demapping section 170 provides the output data 175.

Orthogonal frequency division multiplexing maps data from complex-valued signal constellations onto multiple parallel carriers through the IFFT. The set of data carriers modulated by a single iteration of the IFFT is called a symbol, and the data mapped to a single IFFT bin is called a carrier or tone. The complex data mapped to FFT bin k in OFDM symbol l is denoted by X_{l,k}, wherein the full symbol is denoted by Xₗ. OFDM communication systems exploit the properties of the IFFT/FFT modulation and demodulation in order to simplify channel equalization. After the IFFT, each symbol of the OFDM data stream is given a cyclic prefix (CP) before transmission. The cyclic prefix is a copy of the last ν samples of the symbol placed at its beginning.

If the transmitted signal passes through a channel with a slowly varying delay profile h[n] less than ν samples long, the output samples in a properly selected time domain symbol are approximately equal to the data produced by a circular convolution of the average values for each tap in the delay profile h[n] and the time-domain symbol. Since the FFT of the circular convolution between two sequences is the product of their individual FFTs, use of the cyclic prefix converts a single time-domain multi-path channel into a set of parallel AWGN channels. A parallel bank of single-tap equalizers can equalize the full channel, provided the FFT of the delay profile h[n] is known.

If the time-domain OFDM symbol l is passed through a channel with channel impulse response h[n] for 0≦n≦ν, the FFT of the properly selected received data transmitted on carrier k may be represented by:
Y_{l,k}=H_{l,k}X_{l,k}+N_{l,k}, (1)
where H_{l,k} is the FFT of the channel impulse response, N_{l,k} is the FFT of the additive noise, and Y_{l,k} is the FFT of the received data. The frequency-domain equalization (FEQ) depends upon an accurate channel estimate. The equalized data is given by:

$${\hat{X}}_{l , k} = \frac{{Y}_{l , k}}{{\hat{H}}_{l , k}} , \qquad ( 2 )$$

where Ĥ_{l,k} is the channel estimate available to the receiver.

The receiver 150 generates some of the channel estimates required by the FEQ from the scattered pilot carriers transmitted along with the data. The receiver 150 knows the location and value of the scattered pilot carriers, and can generate the channel estimate Ĥ_{l,k} as follows:

$${\hat{H}}_{l , k} = \frac{{Y}_{l , k}}{{H}_{l , k}^{Pilot}} . \qquad ( 3 )$$

A pilot carrier pattern determines the type of channel estimation algorithm used by the receiver 150.

The image-rejecting channel estimator 166 includes an estimation interpolator 167 and an image-rejection formatter 168. The estimation interpolator 167 is configured to provide channel estimates through time interpolation and frequency interpolation employing the scattered pilot channel estimates. The image-rejection formatter 168 is coupled to the estimation interpolator 167 and is configured to provide image-rejection filtering to suppress an image in an output spectrum of the channel estimates from at least one of the time interpolation and frequency interpolation.

The estimation interpolator 167 provides interpolation filters that are finite impulse response (FIR) low-pass filters. The pass bands of these filters are designed to select information from the scattered pilots that is relevant to the channel estimates. The interpolation filters are provided with an under-sampled series of channel estimates. The spectrum of the input series contains several images (or aliases) of the desired channel estimate spectrum. The image location is related to the scattered pilot pattern wherein their widths depend upon the channel delay and Doppler spreads associated with a received signal. The image-rejecting interpolation filters contain notches in the stop band that are designed to increase the rejection of these unwanted channel estimate spectrum images.

The image-rejection formatter 168 may operate in at least two modes, which include a fixed format mode and an adaptive format mode. In one embodiment employing the fixed format mode, time and frequency interpolation parameters are fixed for a reception period, and the parameters employed for image-rejection filtering remain substantially constant. In an alternative embodiment employing the adaptive format mode, the image-rejection formatter 168 monitors parameters associated with the receiver 150 as it operates to determine changes in pertinent time and frequency interpolation parameters, such as Doppler and delay spreads, for example. Additionally, the image-rejection formatter 168 may employ cyclic shifting and scaling over time as appropriate to a particular application.

In the latter case, the image-rejection formatter 168 may adapt image-rejecting notches associated with time interpolation filtering to appropriately accommodate a change in the Doppler spectrum. Correspondingly, the image-rejection formatter 168 may also adapt image-rejecting notches associated with frequency interpolation filtering to appropriately accommodate a change in the delay profile h[n]. Of course, other receiver parameters may also be monitored and employed in the adaptive format mode to adapt filtering parameters and maintain a desired level of interpolation filter performance.

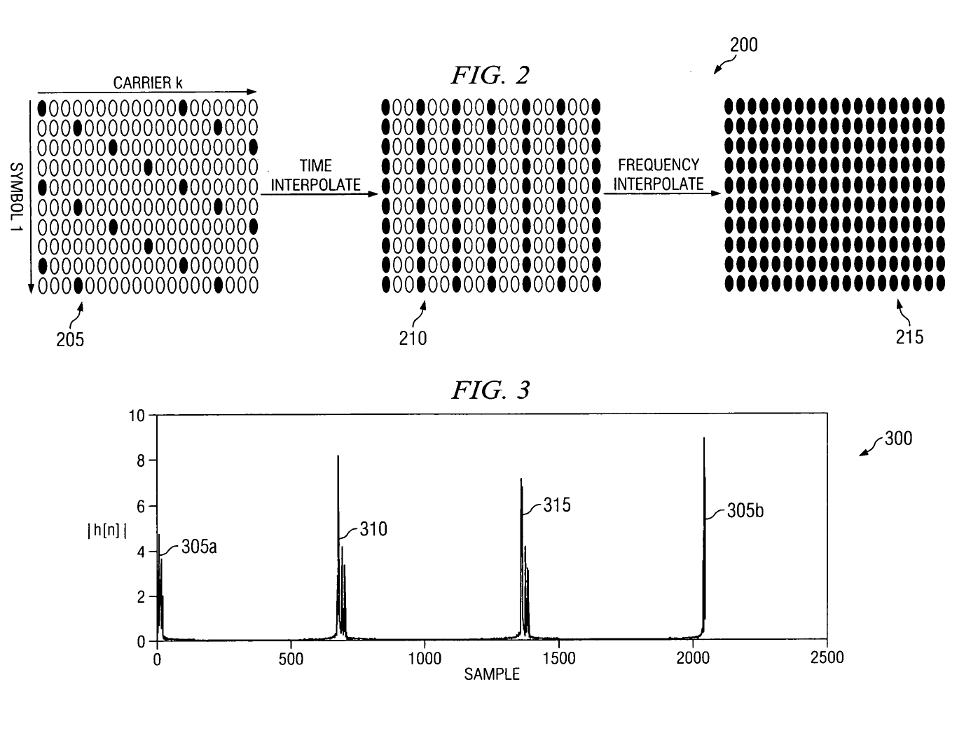

Turning now to FIG. 2, illustrated is a diagram of an embodiment of a symbol-carrier matrix, generally designated 200, showing three stages of channel estimate populations. The symbol-carrier matrix 200 includes a pilot carrier pattern 205, a time interpolation pattern 210 and a frequency interpolation pattern 215.

The Digital Video Broadcast (DVB) standard employing scattered pilots is used as an example in the illustrated embodiment, wherein pilot data is transmitted on one-twelfth of the carriers in each OFDM symbol. The grid of equally spaced pilot carriers shifts three carriers between two symbols as may be seen in the pilot carrier pattern 205.

Interpolation filtering generates channel estimates for the remainder of the data carriers in an OFDM system employing scattered pilot channel estimates. The interpolation is broken into two stages to reduce its computational complexity. A first stage of interpolation runs along the time dimension wherein channel estimates from multiple OFDM symbols in a fixed carrier are combined. After time interpolation, channel estimates are available in one-third of the carriers in each OFDM symbol as may be seen in the time interpolation pattern 210. Subsequently, frequency interpolation filtering generates channel estimates for all of the carriers in each symbol as may be seen in the frequency interpolation pattern 215.

Time and frequency interpolation filtering exploit the constraints on the channel delay profile h[n] imposed by the cyclic prefix. That is, any channel delay profile h[n] shorter than the duration of the cyclic prefix may be equalized. Therefore, time and frequency interpolation filtering are able to accurately estimate the channel responses for any channel delay profile h[n] satisfying this condition.

The time and frequency interpolation filter operations are equivalent to windowing the IFFT of the pilot carrier and time interpolation filtering outputs, respectively. Since pilot carrier filtering produces channel estimates that are under-sampled by a factor of four, the IFFT of these channel estimates will produce four replicas of the channel Doppler spectrum. Similarly, since time interpolation filtering produces channel estimates that are under-sampled by a factor of three, the IFFT of these channel estimates will produce an additional three replicas of the channel delay profile h[n]. In one embodiment of the present invention, both the time and frequency interpolation filters are low-pass filters having image-rejecting notches in their stop band to suppress the undesired images of the channel Doppler spectrum or delay profile h[n].

Turning now to FIG. 3, illustrated is an IFFT magnitude of a time interpolation output, generally designated 300, showing undesired images of the communication channel delay profile h[n]. The time interpolation output 300 includes a desired response indicated by 305a, 305b and first and second undesired image responses 310, 315. The first and second undesired image responses 310, 315 are exemplary of the images that are generated when employing the time interpolation pattern 210 of FIG. 2. As noted above, three additional undesired image responses (not shown in FIG. 3) are also generated when employing the pilot carrier pattern 205 of FIG. 2.

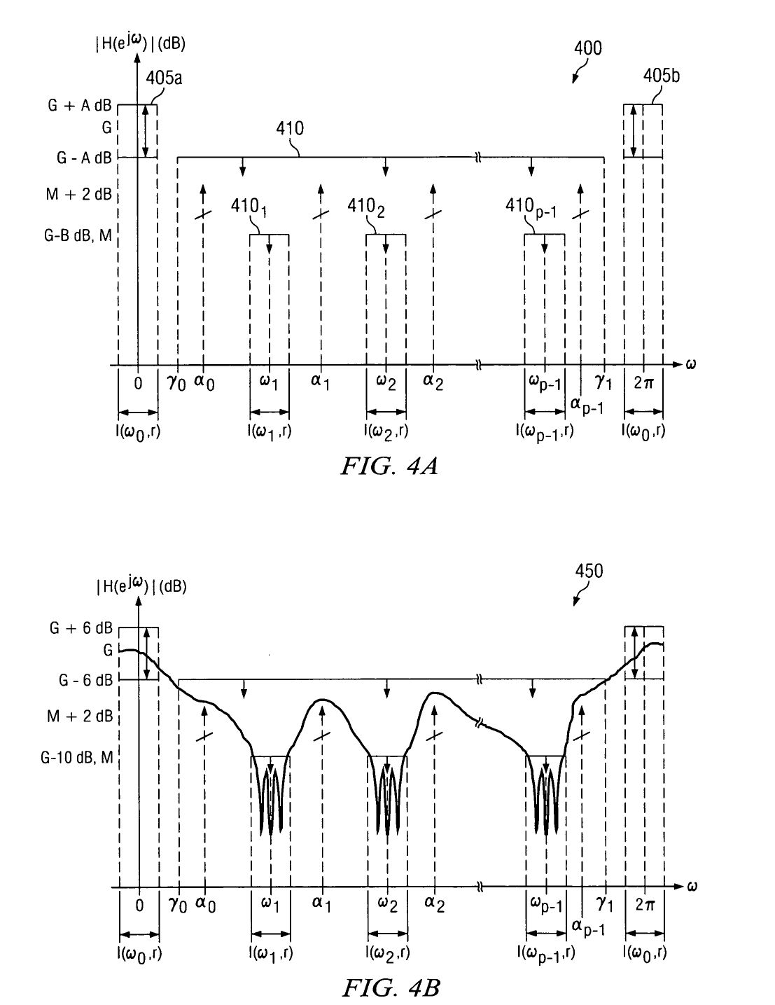

Turning now to FIG. 4A, illustrated is a windowing diagram of an embodiment of an image-rejecting filter template, generally designated 400, constructed in accordance with the principles of the present invention. The image-rejecting filter template 400 defines a general filter structure that includes a filter pass band region 405a, 405b that accommodates a desired channel estimate and a filter stop band region 410 having a collection of stop-band notches 410₁-410ₚ₋₁ that provide suppression of undesired images.

The image-rejecting filter template 400 defines a set of requirements associated with an image-rejection filter that may be employed for the design of time and frequency interpolation filter embodiments for channel estimation. The first three requirements address an input sequence as a function of the spacing between non-zero samples, which will produce a DFT having images.

As a first requirement, the image-rejection interpolation filter produces an output by a linear combination of samples from an input series. As a second requirement, the input series provides a fixed proportion of input samples from the input series that are non-zero. As a third requirement, the non-zero input samples are spaced by a fixed number of input samples equal to zero. The Discrete-Time Fourier Transform (DTFT) of the impulse response f[n] is employed to describe the remaining requirements of the image-rejection interpolation filter. The DTFT is denoted by F(e^{jω}) and is a complex-valued function of the angle variable ω with period 2π.

The remaining requirements of an image rejecting interpolation filter also concern the behavior of F(e^{jω}) near a grid of q frequencies denoted by {ω₀, ω₁, . . . , ω_{q-1}}. The location of these points falls between 0 and 2π. The points are ordered such that ωᵢ<ωᵢ₊₁ for all i. There is a constant r and an interval I(ωᵢ,r) around each point in the grid, denoted by I(ωᵢ,r)=[ω_{min,i}, ω_{max,i}], such that |ω_{max,i}−ω_{min,i}|=r and ω_{min,i}≦ωᵢ≦ω_{max,i}. The same constant r is used for each interval.

The grid of q frequencies denotes the centers of each of the images, where the q frequencies occur in order. The constant r is related to the maximum Doppler spread of a channel or the maximum delay spread of the channel. The Doppler spread is a measure of how the channel changes from symbol to symbol at a particular frequency. This indicates the breadth of the images that a time interpolation filter will encounter at its input. For a frequency interpolation filter, the constant r is related to the delay spread of the channel, wherein the delay spread is the difference between a first signal arrival and its last arrival in a multi-path communication channel. Therefore, the constant r is a specification design variable that allows adjusting the image-rejecting filter for a maximum Doppler or delay spread to be encountered. The interval I(ωᵢ,r) is an interval of frequency having a width r that contains the centers of the images.

A fourth requirement of an image rejecting interpolation filter is that the DTFT satisfy 20 log₁₀(∥F(e^{jω})−G∥)≦−A dB for all points in the interval I(ω₀,r). The constant G is a number larger than one that is related to the spacing between non-zero input samples. The filter frequency response in the pass band 405 is constrained to be no more than an amount of A dB from the constant G. This property provides a condition to select the desired response for the channel estimate in the filter pass band 405 identified by the interval I(ω₀,r) and having a ripple that is less than A dB.

The constant G is typically the spacing between the pilots. In the example of FIG. 2, the constant G equals three for frequency interpolation and the constant G equals four for time interpolation. For a channel where energy is evenly distributed across all of the carriers, time interpolation filtering may increase the magnitude of the desired response by a factor of four and frequency interpolation filtering may increase it by a factor of three.

As a fifth requirement, the DTFT satisfies 20 log₁₀(∥F(e^{jω)∥)≦}20 log₁₀(G)−B dB for all points in each interval I(ωᵢ,r) excluding I(ω₀,r). This requirement dictates the presence of a ceiling for the image-rejecting notches of the constant G diminished by a quantity of B dB to assure suppression of the undesired images.

As a sixth requirement, ∥F(e^{jω})∥ contains at least one local maximum in each interval I(ωᵢ,r). The local maximum is a characteristic that distinguishes the image-rejecting filter from other filters having only a “V-shaped” notch characteristic. The local maximum response is represented by the filter response rising from the notch, turning around and going back toward zero and then come up again before leaving the notch.

As a seventh requirement, there are frequencies {α₀, α₁, . . . , αₚ₋₁} satisfying ωᵢ<αᵢ<ωᵢ₊₁ for i=0, . . . , p−2 and ωₚ₋₁<αₚ₋₁<2π where the filter DTFT satisfies 20 log₁₀(∥F(e^{jα}^{ᵢ})∥)≧M+2 dB employing the value M as the maximum value of ∥F(e^{jω})∥ over the union of the intervals {I(ωᵢ,r)}, excluding I(ω₀,r). The frequencies {α₀, α₁, . . . , αₚ₋₁} either fall between every pair of notches or between a notch and the filter pass band 405. At each of the frequencies {α₀, α₁, . . . , αₚ₋}, the filter response is above the notches by at least 2 dB.

As an eighth requirement, there are two frequencies γ₀ and γ₁ such that 0<γ₀<ω₁ and ωₚ₋₁<γ₁<2π where 20 log₁₀(∥F(e^{jω)∥)≦}20 log₁₀(G)−A dB for all points between γ₀ and γ₁, which defines the filter stop band 410.

Turning now to FIG. 4B, illustrated is a windowing function of an embodiment of an image-rejection filter, generally designated 450, employing the image-rejecting filter template of FIG. 4A. The image-rejection filter 450 demonstrates how a general windowing function meets the requirements presented in FIG. 4A for the factors A dB and B dB corresponding to 6 dB and 10 dB, respectively.

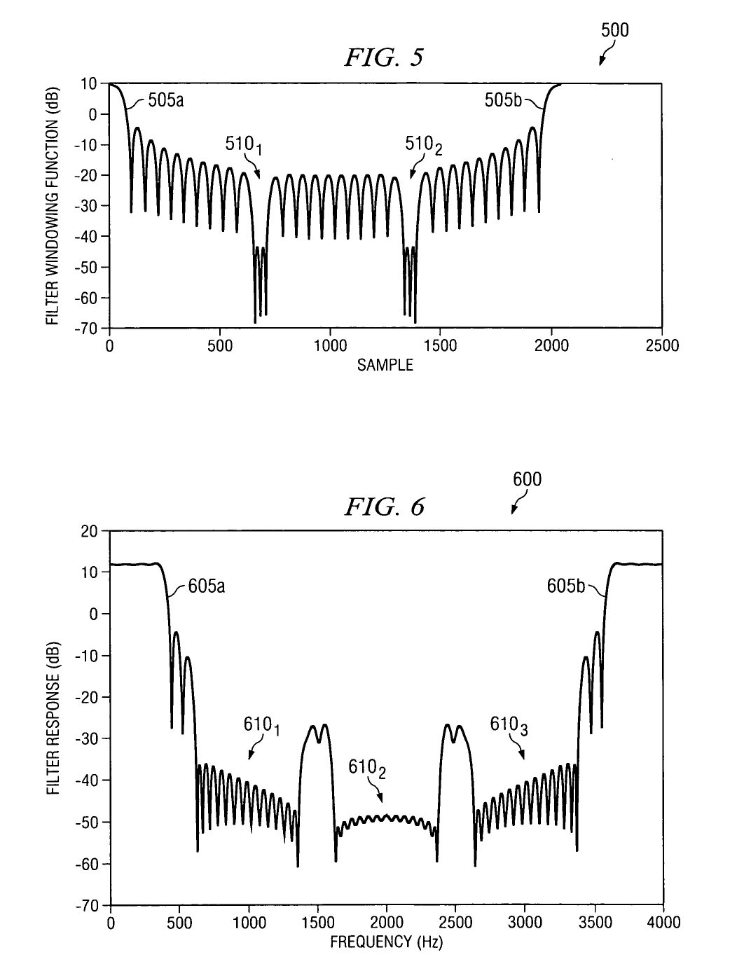

Turning now to FIG. 5, illustrated is a windowing function of an embodiment of image-rejecting frequency interpolation filter, generally designated 500, constructed according to the principles of the present invention as may be employed for the input data pattern 210 shown in FIG. 2. The image-rejecting frequency interpolation filter 500 includes a filter pass band 505a, 505b, and first and second stop band notches 510₁, 510₂ constructed in accordance with the filter restrictions corresponding to the image-rejecting filter template 400 as discussed with respect to FIG. 4A.

The image-rejecting frequency interpolation filter 500 provides an equivalent window for the image-rejecting frequency interpolation filter design corresponding to a 2048-point FFT with a 64-sample cyclic prefix and is cyclically-centered around tap zero. The width of the image-rejecting frequency interpolation filter 500 is given by the ratio of the cyclic prefix size to the FFT block size. The stop band contains two notches to substantially eliminate the first and second undesired images 310, 315 of FIG. 3 that are produced by under-sampling of the channel frequency response.

The frequency interpolation filter coefficients used depend upon the cyclic prefix size and an FFT block size. A set of coefficients for each guard interval and FFT combination may be stored. The frequency interpolation filter coefficients may be chosen on the basis of the guard interval and FFT block size, or alternatively, on the basis of the delay profile of the multi-path channel.

If the channel delay profile fits within a guard interval that is smaller than the one used by the transmitter 105, the frequency interpolation filter coefficients associated with the smaller guard interval may be used. For example, the delay profile duration in FIG. 2 is less than one-eighth of the FFT block duration when the guard interval used by the transmitter 105 of FIG. 1 is one-fourth of the FFT block. Therefore, choosing the frequency interpolation filter coefficients based upon the delay profile estimate may improve the performance of the frequency interpolation channel estimation in situations where the guard interval significantly exceeds the channel delay profile duration.

In one embodiment of the invention, the image-rejecting frequency interpolation filter is derived from a minimum mean square error (MMSE) estimation formulation. For a particular channel gain, H_{l,k}, the MMSE may be determined given the cyclic prefix size of the channel N_{CP} and the FFT block size N. The channel gain is estimated from a set L_{f} of scattered pilot carriers selected by a symmetric window around carrier k. The data used for the frequency interpolation estimation are collected in the vector:

$${\vec{H}}_{P}^{FI} = [ \begin{matrix}{H}_{l , {s}_{1}} \\ {H}_{l , {s}_{2}} \\ ⋮ \\ {H}_{l , {s}_{{L}_{f}}}\end{matrix} ] . \qquad ( 4 )$$

Unless k is an edge tone, the carriers {s₁, s₂, . . . , s_{L}_{_{f}}} are selected in a symmetric pattern around the channel gain to be estimated. The first half are in FFT bins with indices smaller than k and the last half are in FFT bins with indices larger than k. The statistical model for the frequency interpolation may be designed on the assumption that the channel is time-invariant. The impulse response paths are assumed to have correlation given by E[h[m]h*[n]]=δ[m−n]. The correlation between channel gains becomes:

$$\begin{matrix}E [ {H}_{l , {k}_{1}} {H}_{l , {k}_{2}}^{*} ] = \frac{1}{N} {\sum }_{n = - {N}_{CP} \text{/} 2}^{{N}_{CP} \text{/} 2 - 1} {\sum }_{m = - {N}_{CP} \text{/} 2}^{{N}_{CP} \text{/} 2 - 1} E [ h [ m ] {h}^{*} [ n ] ] {ⅇ}^{j \frac{2 }{N} {k}_{1} n} {ⅇ}^{- j \frac{2 }{N} {k}_{2} m} , \\ E [ {H}_{l , {k}_{1}} {H}_{l , {k}_{2}}^{*} ] = \frac{1}{N} {\sum }_{n = - {N}_{CP} \text{/} 2}^{{N}_{CP} \text{/} 2 - 1} {ⅇ}^{j \frac{2 }{N} ( {k}_{1} - {k}_{2} ) n} .\end{matrix} \qquad ( 5 )$$

The indices in the summations run from −N_{CP}/2 to N_{CP}/2−1 due to a circular shift by half the cyclic prefix length applied prior to the FFT. This makes the resulting correlation value real rather than complex.

The summation for the correlation of channel gains becomes:

$$E [ {H}_{l , {k}_{1}} {H}_{l , {k}_{2}}^{*} ] = \frac{{N}_{CP}}{N} diric ( \frac{2 π}{N} ( {k}_{1} - {k}_{2} ) , {N}_{CP} ) , \qquad ( 6 )$$

where the diric function represents the discrete-time sinc function given by:

$$diric ( x , P ) = \{ \begin{matrix}\frac{sin ( P x \text{/} 2 )}{P sin ( x \text{/} 2 )} \\ \\ 1 x = 2 π k , k even \\ - 1 x = 2 π k , k odd .\end{matrix} \qquad ( 7 )$$

In the illustrated embodiment, the steady-state image-rejecting frequency interpolation filter is derived from the MMSE estimate of the channel gains. The filters for the three locations of the carrier relative to the intermediate channel estimates produce the three phases of the third order polyphase decomposition of the image-rejecting frequency interpolation filter. These three sub-filters are interleaved to form the final filter. Thus, the time interpolation weights for H_{l,k} form a filter based upon the data in the vector:
\vec{Y}_{P}=\vec{H}ₚ^{FI}+N. (8)
The frequency interpolation weights for carrier k take the familiar form:
\vec{w}ₗ=E[\vec{Y}_{P}\vec{Y}_{P}^{H}]⁻¹E[\vec{Y}_{P}H*_{l,k}], (9)
and the time interpolated channel value is:
Ĥ_{l,k}=\vec{w}ₗ^{H}\vec{Y}_{P}. (10)

The correlation matrix E[\vec{Y}_{P}\vec{Y}_{P}^{H}]⁻¹ may be generated as the sum between a matrix composed of correlation components between the channel coefficients and the matrix σ²I, where σ² is the noise variance. The vector E[\vec{Y}_{P}H*_{l,k}] may be described in terms of channel correlations since the channel and noise are uncorrelated.

The expression for the channel estimate in carrier k, Ĥ_{l,k}=\vec{w}ₗ^{H}\vec{Y}_{P} shows that a final channel estimate is a linear combination of the time interpolation outputs. In the illustrated embodiment, these outputs are generated every three carriers. The estimator coefficients in \vec{w}ₗ depend only upon the relative spacing between carrier k and the time interpolation output grid. There are three values for this vector, depending upon whether k falls directly on a scattered pilot, one carrier to the right of a scattered pilot or one carrier to the left of a scattered pilot.

Thus, only three sets of estimator coefficients are needed to generate frequency interpolated channel estimates for every carrier in the OFDM symbol. These sets of coefficients may be interleaved so that the channel estimation operation can be implemented as a standard finite impulse response (FIR) filter. If there are L_{f} elements in each realization of \vec{w}ₗ, a filter of size 3L_{f} implements the channel estimation wherein one of the realizations of \vec{w}ₗ overlaps the carriers containing time interpolation outputs for each placement of the filter. Alternatively, the filtering can be implemented in polyphase form to exploit the under-sampled input data. Only multiplications between non-zero input samples and filter coefficients are performed.

The convolution between the frequency interpolation filter and the time interpolation output produces the final channel estimates in the frequency domain. The equivalent time domain channel may be generated by windowing the equivalent time domain channel generated by the time interpolation operation with a window produced by taking the FFT of the image-rejecting frequency interpolation filter.

Turning now to FIG. 6, illustrated is a windowing function of an embodiment of an image-rejecting time interpolation filter, generally designated 600, constructed according to the principles of the present invention as may be employed for the pilot carrier pattern 205 shown in FIG. 2. The image-rejecting time interpolation filter 600 includes a filter pass band 605a, 605b and first, second and third stop band notches 610₁. 610₂, 610₃ constructed in accordance with the filter restrictions corresponding to the image-rejecting filter template 400 as discussed with respect to FIG. 4A.

The time interpolation filter for the pilot carrier pattern 205 shown in FIG. 2 above generates channel estimates in every symbol from a sequence of scattered pilot channel estimates available in one-fourth of the OFDM symbols. With an appropriate statistical model, four sets of time interpolation weights may be generated to estimate channel coefficients from the available scattered pilot estimates. These four sets of weights may be interleaved to form a single FIR filter to implement the time interpolation operation. As with the frequency interpolation filter, the equivalent window function for the filter will have a non-equiripple stopband. A seen in the embodiment of FIG. 6, there are three deep notches in a stop band to suppress the undesired images or aliases of the channel Doppler spectrum.

The statistical model used to design the time interpolation filter begins with a correlation between channel taps in the time domain. The time interpolation filter models the channel as a linear time-varying system. The correlation between the channel gains at times t₁ and t₂ may be modeled, for example, by the Bessel function of order zero wherein this model is typically used to describe Rayleigh fading channels. Once the correlation between channel taps in the time domain is established, the procedure described above may be employed to generate the correlation between the frequency domain channel coefficients. Additionally, it may be used to generate the realizations of the four sub-filters that are interleaved to form the final time interpolation filter.

Note that the time interpolation filter design achieves image-rejecting notches in its stop band with a different correlation function used in the MMSE computations than was given in equation (9). Thus, the image-rejecting channel estimation filter design is not limited to using the correlation functions used herein. An MMSE filter design based on any correlation function that produces image-rejecting notches in its stop band may be employed as an alternative embodiment of the present invention.

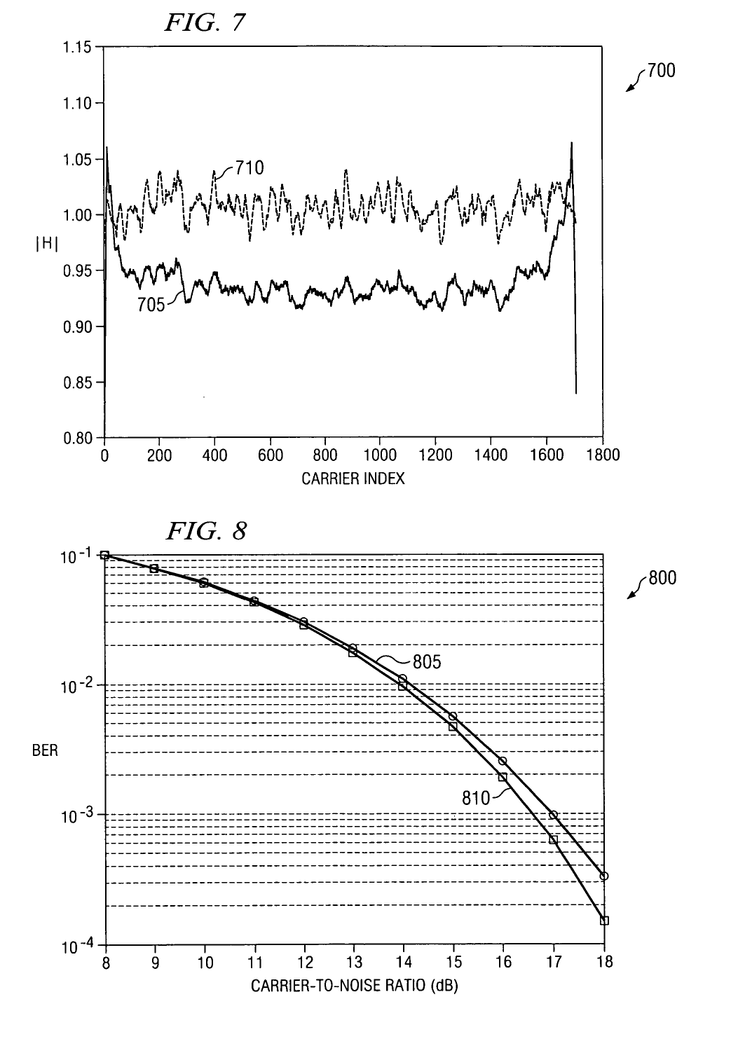

Turning now to FIG. 7, illustrated is a comparative chart of channel estimate magnitudes, generally designated 700, showing an enhancement afforded by image-rejecting channel estimation. The comparative chart 700 includes least-squares frequency interpolation channel estimation 705 and image-rejecting frequency interpolation channel estimation 710. The comparison was done for an AWGN channel wherein the expected channel estimate magnitude is constant at a value of one. The comparison uses the scattered pilot pattern from a transmitter with a 2048-point FFT and a 64 sample cyclic prefix. As may be seen in FIG. 7, the image-rejecting frequency interpolation channel estimation 710 provides an enhancement in channel estimation of about five percent over the least-squares frequency interpolation channel estimation 705.

Turning now to FIG. 8, illustrated is a comparative chart of bit error rates, generally designated 800, showing an enhancement afforded by image-rejecting channel estimation. The comparative chart 800 includes a least-squares frequency interpolation bit error rate (BER) curve 805 and an image-rejecting frequency interpolation BER curve 810. The comparative chart 800 shows BERs for the two frequency interpolators employing a simulation with an uncoded 16-QAM constellation on the AWGN channel. At BERs below 10⁻³, the image-rejecting frequency interpolation may be seen to improve BER performance by up to 0.5 dB.

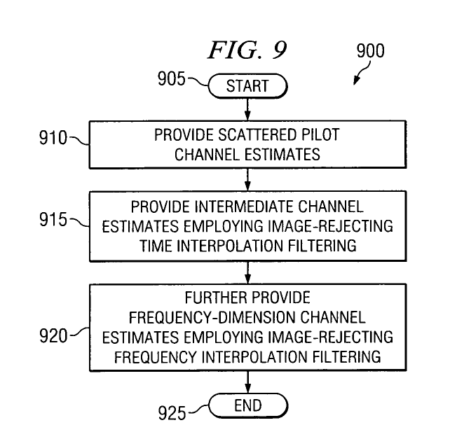

Turning now to FIG. 9, illustrated is a flow diagram of an embodiment of a method of image-rejecting channel estimating, generally designated 900, carried out in accordance with the principles of the present invention. The method 900 is for use with an OFDM receiver employing scattered pilot data and starts in a step 905. Then, in a step 910, scattered pilot channel estimates are provided employing the scattered pilot data, and the scattered pilot channel estimates are employed to provide intermediate channel estimates using image-rejecting time interpolation filtering for a portion of carriers associated with the scattered pilot channel estimates, in a step 915.

In a step 920, final channel estimates are further provided by employing image-rejecting frequency interpolation filtering of the intermediate channel estimates generated by interpolation channel estimation acting on the scattered pilot channel estimates. Additionally, the image-rejecting frequency interpolation filtering equalizes communication channel impulse responses that are shorter than a corresponding transmission cyclic prefix. The step 920 provides at least one windowing function having notches aligned with spurious images generated by the interpolation filtering. In one embodiment, the image-rejecting frequency interpolation filtering enhances channel estimation by about five percent and improves a bit error rate by about 0.5 dB. The method 900 ends in a step 925.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing an image-rejecting channel estimator, a method of image-rejecting channel estimating and an OFDM receiver employing the estimator or the method have been presented. Advantages include an approach that allows separation of time and frequency interpolation filtering for channel estimation based on scattered pilots in the OFDM receiver, a finite length time interpolation filter designed to eliminate undesired images of the channel Doppler spectrum arising from the under-sampled input and a finite length frequency interpolation filter designed to eliminate undesired images of the channel profile spread arising from the under-sampled input.

Performance is improved over time and frequency interpolators designed with a least-squares criterion, since channel estimate degradation due to these spurious and undesired images of the channel impulse response are appropriately addressed. The approach adds deep notches in the equivalent filter window in order to eliminate these undesired images. This design improves performance of the OFDM receiver at high signal-to-noise ratios by about 0.5 dB, in one embodiment. Additionally, the time and frequency interpolation filters may be designed to approximate a desired time domain windowing under the constraint of finite length.

Although the present invention has been described in detail, those skilled in the art should understand that they can make various changes, substitutions and alterations herein without departing from the spirit and scope of the invention in its broadest form.

What is claimed is:

1. An image-rejecting channel estimator for use with an orthogonal frequency division multiplex (OFDM) receiver employing scattered pilot channel estimates, comprising:
an estimation interpolator configured to provide channel estimates through time interpolation and frequency interpolation employing said scattered pilot channel estimates; and
an image-rejection formatter coupled to said estimation interpolator and configured to provide image-rejection filtering to suppress an image in an output spectrum of said channel estimates from at least one of said time interpolation and frequency interpolation.

2. The estimator as recited in claim 1 wherein said image-rejection filtering provides a pass band for said channel estimates and a stop band having at least one image-rejecting notch corresponding to said images generated by at least one of said time interpolation and frequency interpolation.

3. The estimator as recited in claim 1 wherein said image-rejection filtering is based on one selected from the group consisting of:
a fixed format mode; and
an adaptive format mode.

4. The estimator as recited in claim 1 wherein a width of an image-rejecting notch provided by said image-rejection filtering is based on one selected from the group consisting of:
a Doppler-shifted receive signal; and
a delayed receive signal.

5. The estimator as recited in claim 1 wherein said image-rejection filtering employs a poly-phase format.

6. The estimator as recited in claim 1 wherein an image-rejecting notch employed in said image-rejection filtering provides a response having a local maximum.

7. The estimator as recited in claim 1 wherein said image-rejection filtering provides image-rejecting notches that are cyclically shifted to suppress said images.

8. The estimator as recited in claim 1 wherein said image-rejection filtering employs a scale factor to modify an amplitude response.

9. A method of image-rejection channel estimating for use with an orthogonal frequency division multiplex (OFDM) receiver employing scattered pilot channel estimates, comprising:
providing channel estimates through time interpolation and frequency interpolation employing said scattered pilot channel estimates; and
providing image-rejection filtering to suppress an image in an output spectrum of said channel estimates from at least one of said time interpolation and frequency interpolation.

10. The method as recited in claim 9 wherein said image-rejection filtering provides a pass band for said channel estimates and a stop band having at least one image-rejecting notch corresponding to said images generated by at least one of said time interpolation and frequency interpolation.

11. The method as recited in claim 9 wherein said image-rejection filtering is based on one selected from the group consisting of:
a fixed format mode; and
an adaptive format mode.

12. The method as recited in claim 9 wherein a width of an image-rejecting notch provided by said image-rejection filtering is based on one selected from the group consisting of:
a Doppler-shifted receive signal; and
a delayed receive signal.

13. The method as recited in claim 9 wherein said image-rejection filtering employs a poly-phase format.

14. The method as recited in claim 9 wherein an image-rejecting notch employed in said image-rejection filtering provides a response having a local maximum.

15. The method as recited in claim 9 wherein said image-rejection filtering provides image-rejecting notches that are cyclically shifted to suppress said images.

16. The method as recited in claim 9 wherein said image-rejection filtering employs a scale factor to modify an amplitude response.

17. An orthogonal frequency division multiplex (OFDM) receiver employing scattered pilot data, comprising:
a guard band removal section coupled to a communication channel;
a fast Fourier transform (FFT) section coupled to said guard band removal section;
a channel estimation section, coupled to said FFT section, that provides scattered pilot channel estimates from said scattered pilot data;
an image-rejecting channel estimator, coupled to said channel estimation section, including:
an estimation interpolator that provides channel estimates through time interpolation and frequency interpolation employing said scattered pilot channel estimates, and
an image-rejection formatter, coupled to said estimation interpolator, that provides image-rejection filtering to suppress an image in an output spectrum of said channel estimates from at least one of said time interpolation and frequency interpolation; and
a demapping section, coupled to said channel estimation section, that provides output data.

18. The receiver as recited in claim 17 wherein said image-rejection filtering provides a pass band for said channel estimates and a stop band having at least one image-rejecting notch corresponding to said images generated by at least one of said time interpolation and frequency interpolation.

19. The receiver as recited in claim 17 wherein said image-rejection filtering is based on one selected from the group consisting of:
a fixed format mode; and
an adaptive format mode.

20. The receiver as recited in claim 17 wherein a width of an image-rejecting notch provided by said image-rejection filtering is based on one selected from the group consisting of:
a Doppler-shifted receive signal; and
a delayed receive signal.

21. The receiver as recited in claim 17 wherein said image-rejection filtering employs a poly-phase format.

22. The receiver as recited in claim 17 wherein an image-rejecting notch employed in said image-rejection filtering provides a response having a local maximum.

23. The receiver as recited in claim 17 wherein said image-rejection filtering provides image-rejecting notches that are cyclically shifted to suppress said images.

24. The receiver as recited in claim 17 wherein said image-rejection filtering employs a scale factor to modify an amplitude response.
